(19) United States
(12) Patent Application Publication
(10) Pub. No.: US 2008/0121777 A1
(43) Pub. Date: May 29, 2008

(54) ROD HOLDER

(76) Inventor: Kenneth S. Aggus, Independence, MO (US)

Correspondence Address: CHASE LAW FIRM L.C, 4400 COLLEGE BOULEVARD, SUITE 130, OVERLAND PARK, KS, 66211, US

(21) Appl. No.: 11/945,394

(22) Filed: Nov. 27, 2007

Related U.S. Application Data
(60) Provisional application No. 60/861,048, filed on Nov. 27, 2006.

(51) Int. Cl. A01K 97/10

(52) U.S. Cl. 248/528

(57) ABSTRACT

A fishing rod holder is adjustable both in height and in width and is collapsible for shore use.

### CROSS-REFERENCE TO RELATED APPLICATION

This application claims the benefit of a prior filed, co-pending application Ser. No. 60/861,048, filed on Nov. 27, 2006 entitled SHORE THING ROD HOLDER.

### TECHNICAL FIELD OF THE INVENTION

The present invention relates to the general art of fishing, and to the particular field of fishing accessories.

### BACKGROUND OF THE INVENTION

A fisherman often grows weary of continuously holding a fishing rod when fishing for an extended period of time, particularly when fishing with live bait where repeated casting and reeling is unnecessary. Accordingly, the fisherman often attempts to prop the fishing rod up using any available support means, such as a forked stick or a pile of rocks. These natural supports, however, are typically unstable and unreliable to hold the rod in a desired position for a significant period of time.

Various devices exist for supporting a fishing rod. Although assumably effective in operation, such devices are either complex and expensive in their construction or do not provide adequate adjustability of both the height and angle at which a fishing rod is held. Further, existing devices are not collapsible wholly within a base such that the elements of the device cannot be snagged on tree branches, underbrush, or the like during transport.

Therefore, it is desirable to have a fishing rod support assembly which can be selectively adjusted to hold a fishing rod at a desired height above the ground. It is also desirable to have a fishing rod support assembly which can be adjusted to hold the fishing rod at a desired angle of elevation. Finally, it is desirable to have a fishing rod support assembly which is collapsible within a base such that assembly elements cannot be snagged during transport through underbrush, etc.

### SUMMARY OF THE INVENTION

These, and other, objects are achieved by a fishing rod holder that is adjustable both in height and in width and is collapsible for shore use.

### BRIEF DESCRIPTION OF THE DRAWINGS

FIG. 1 is a perspective view of a fishing rod holder embodying the present invention in 5 a closed condition.

FIG. 2 is an end elevational view thereof.

FIG. 3 shows the fishing rod holder in a collapsed condition for storage.

### DETAILED DESCRIPTION OF THE PREFERRED EMBODIMENT

Other objects, features and advantages of the invention will become apparent from a consideration of the following detailed description and the accompanying drawings.

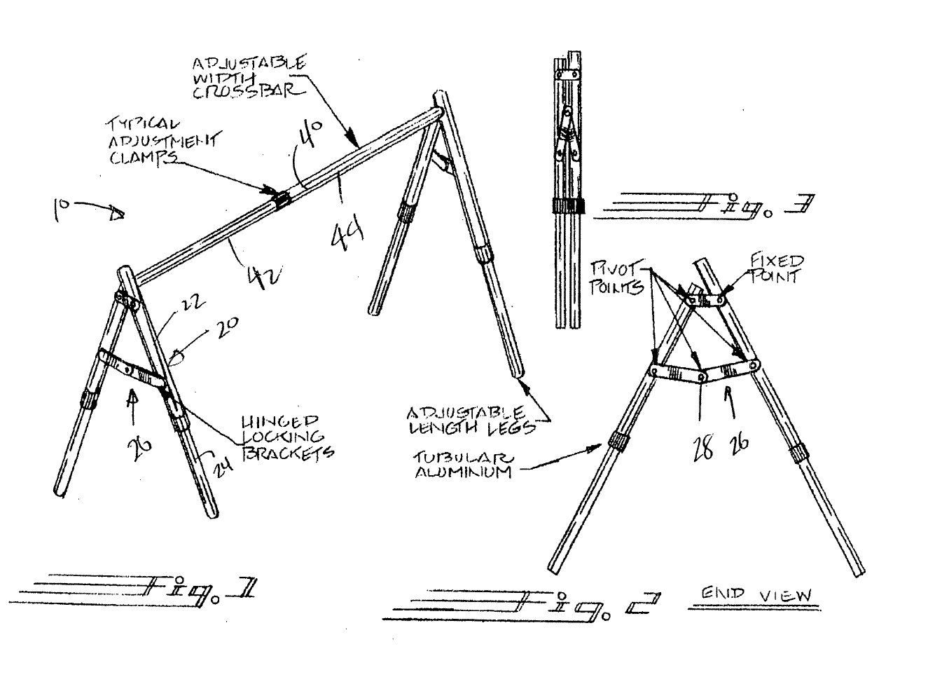

Referring to the figures, it can be understood that the present invention is embodied in a fishing rod holder 10 that is adjustable both in height and in width so it can be easily used on shore. Holder 10 includes legs 20 that include telescopingly connected sections 22 and 24 and which are in the form of a V and which have a cross brace 26 hingedly connected thereto and which includes a pivot pin 28. A cross beam 40 is formed of a telescoping sections 42 and 44 and connects the leg units together when the holder is in the set up condition as shown in FIG. 1.

The telescoping sections can be collapsed and the cross braces can be unhooked so the holder can be collapsed from the set configuration shown in FIG. 1 to a collapsed, storage, condition shown in FIG. 2.

It is understood that while certain forms of the present invention have been illustrated and described herein, it is not to be limited to the specific forms or arrangements of parts described and shown.

Having thus described the invention, what is claimed as new and desired to be secured by Letters Patent is:

1. A fishing rod holder comprising:
a first pair of legs each having a top end and a bottom end and being comprised of an upper section and a lower section, said lower section being telescopically extendable from said upper section, said first pair of legs pivotally fastened together at said top end,
a second pair of legs each having a top end and a bottom end and being comprised of an upper section and a lower section, said lower section being telescopically extendable from said upper section, said first pair of legs pivotally fastened together at said top end,
a cross beam having a first end and a second end and being comprised of a first section and a second section, said second section being telescopically extendable from said first section, said first end releasably secured to said top ends of said first pair of legs, said second end releasably secured to said top ends of said second pair of legs,
a first cross brace hingedly connected between said upper sections of said first pair of legs,
a second cross brace hingedly connected between said upper sections of said second pair of legs,
wherein each leg of said first and second pair of legs may be independently extended,
wherein said cross beam may be extended to accommodate one or more fishing rods.

2. The fishing rod holder as set forth in claim 1 further comprising a rubber foot secured to the bottom end of each leg.

3. The fishing rod holder as set forth in claim 1 further presenting a set configuration wherein said fishing rod holder is configured to support one or more fishing rods, and a collapsed configuration wherein said fishing rod holder is collapsed for storage.
